(19) United States
(12) Patent Application Publication
(10) Pub. No.: US 2020/0166103 A1
(43) Pub. Date: May 28, 2020

(54) DIVIDED GEAR WHEEL FOR AN AUTOMATIC POWER TRANSMISSION SYSTEM

(71) Applicant: Leonidas Kyros Kontopoulos, Frankfurt am Main (DE)

(72) Inventors: Konstantinos Kontopoulos, Frankfurt am Main (DE); Grigorios Kontopoulos, Frankfurt am Main (DE)

(73) Assignees: Leonidas Kyros Kontopoulos, Frankfurt am Main (DE); Kyros Philippos Kontopoulos, Frankfurt am Main (DE)

(21) Appl. No.: 16/601,897

(22) Filed: Oct. 15, 2019

(30) Foreign Application Priority Data
Nov. 28, 2018 (DE) 102018220492.6

(51) Int. Cl. F16H 3/083; F16H 55/14; F16H 55/17; F16H 37/04; F16H 3/089; F16H 61/684; F16H 63/02

(52) U.S. Cl. CPC F16H 3/083; F16H 55/14; F16H 55/17; F16H 37/042; F16H 2708/10; F16H 61/684; F16H 63/02; F16H 2702/02; F16H 3/089

(57) ABSTRACT

The present application relates to a divided gear wheel 100, 200, for an automatic power transmission system 1, to an automatic power transmission system and a method to operate said automatic power transmission system. The automatic power transmission system comprises at least one divided gear wheel that comprises an inner part 130, 230, being engageable with a shaft and an outer part 110, 210, comprising teeth, adapted for torque transmission to another gear wheel. The inner part and the outer part have a common rotational axis, and the inner part is at least partially arranged within the outer part. Further, the inner part is coupled to the outer part by means of two elastic elements, so that the inner part is arranged angularly deflectable with respect to the outer part around the common rotational axis. The inner part and the outer part are adapted to rotate with the same angular speed if the elastic elements are fully loaded.

### FIELD OF THE INVENTION

The present application relates to the field of automatic power transmission systems and in particular to a divided gear wheel for an automatic power transmission system, to an automatic power transmission system, to a method to operate an automated power transmission system and to an automotive vehicle comprising an automatic power transmission system.

### BACKGROUND

Known automotive vehicles, such as trucks, cars, motorbikes or the like, use power transmission systems (e.g. gearboxes) in order to provide a range of speed and torque outputs, which are necessary during the movement of the vehicle.

The power transmission system adapts the output of the engine of the vehicle, typically an internal combustion engine, to the drive wheels. For example, automotive engines may operate at a relatively high rotational speed, which is inappropriate for starting, stopping, and slower travel of the vehicle. The power transmission system thus may reduce higher engine speed to the slower wheel speed, increasing torque in the process. Further, if higher travel speeds (or wheel speeds) are desired, a power transmission system may be designed to increase rotational speed of the engine.

Furthermore, the engine provides its highest torque and power outputs unevenly across the rev range resulting in a torque band and a power band. Often the greatest torque is required when the vehicle is moving from rest or traveling slowly, while maximum power is needed at high speeds. Therefore, a power transmission system is required that transforms the engine's output so that it can supply high torque at low speeds, but also operate at high speeds with the motor still operating within its limits.

In order to cover a wide range of torque and/or rotational speed, typical automotive vehicles comprise gearboxes, having several gears that provide different gear ratios. The gear ratio i is the ratio or the rotational speed of the input gear wheel coin to the rotational speed of the output gear wheel co.

$$i = \frac{{ω}_{in}}{{ω}_{out}}$$

To allow the engine to operate at a desired operating point, such as maximum torque, maximum power, optimal efficiency, known automotive vehicles are equipped with power transmission system having multiple gears. For instance, in order to increase the efficiency of a vehicle and thus saving fuel, the vehicle's engine is desirably operated within the area of Brake Specific Fuel Consumption (BSFC), wherein BSFC is a measure of the fuel efficiency of a combustion engine. The BSFC area varies depending on the design of each specific engine and is dependent on the engine's speed and load. Operating the engine within the BSFC area can be achieved by providing an increased number of gears. This is, as a higher number of gears allows to operate the engine closer to a desired operating point Further, providing more gears allows to cover a wider range of torque and/or rotational speed. Typical cars comprise power transmission systems having at least 5 gears, and trucks or tractors are provided with power transmission systems having at least 16 gears.

Different types of power transmission systems have been developed like manual, semi-automatic and fully automatic systems where gear ratio change occurs automatically as the vehicles moves. With an increasing number of gears, semi-automatic and fully automatic systems became more popular, as frequent manually shifting of gears can be avoided. Automatic transmission systems are transmission systems that allow for an automated shifting of gears and/or gear ratios as the vehicle is in motion without the interference of the driver. Further, some automatic transmission systems allow the driver to change gears by commanding a gear ratio changing action. Accordingly, these automatic transmission systems can be operated fully automatically or based on driver commands. There are numerous automatic power transmission systems such as 1) Traditional torque converter, 2) Automated manual transmission (SAT), 3) Continuously Variable Transmission (CVT), 4) Dual Clutch Transmission (DCI), 5) Direct Shift Gearbox (DSG), 6) Tiptronic Transmission and many others.

However, those known systems cannot continuously transfer power during the automated gear shifting. Further, during gear shifting, these known systems suffer from energy loss due to friction between clutch disks or the like, such as in CVTs and DSGs.

Similar patents to the presented one are published with the following numbers: In the patent document US1162305/30-11-1915 a divided gear wheel with one elastic element is presented. It is well known that without a synchronizing mechanism the engagement is not possible. This means that when there is an absence of clutch disks, the difference in angular velocities between the engaging parts that are going to be engaged have to be significantly small (<20 rpm). Otherwise the engagement via the dog clutch would not take place and the dog clutch teeth will be damaged. Due to the fact that the divided gear wheel has only one elastic element, the spring constant of said elastic element has to be great in accordance to the torque transfer (in case a small spring constant was chosen the elastic element would be plastically deformed). In my proposal the divided gear wheel comprises two elastic elements in a parallel configuration with one element having a smaller spring constant and one having a greater spring constant (adapted to handle the maximum load). The element having a smaller spring constant is partially arranged within the element having a greater spring constant and protrudes out of that element on a front face. The configuration in my proposal where a first elastic element is positioned within a second elastic element and protrudes out of the second elastic element on a front face is considered one of the possible parallel configurations. The first elastic element (smaller spring constant) contributes to a smooth engagement and the second elastic element (greater spring constant) handles the occurring load. Therefore as can be seen, the configuration does not include a divided gear wheel, comprising two elastic elements with the two elastic elements positioned in a compartment formed by gear wheel parts and the set of two elastic elements being consisted by elastic elements with different spring constants and spring lengths in relation to each other.

In the patent document WO 2008/062192/29-05-2008, the inner/outer parts of the divided gear wheel are connected with the help of resilient means, positioned in a series arrangement to overcome torque peaks that may occur during the engagement and therefore act as damping elements. The presented method is a passive method to overcome torque peaks when the engagement takes place.

The engagement takes place when the dog clutch teeth enter the large engagement windows of the inner part of the divided gear wheel and when the dog clutch teeth meet the surface of the inner part of the divided gear wheel, loud grinding noise occurs additionally to the occurring torque peaks. This may damage the divided gear wheel or the dog clutch and this is the reason why resilient means are adopted, but still the danger of an argue of engagement is present, despite the use of resilient means.

In case where the engagement means of the engagement component were in accordance to the engagement means of inner part of divided gear wheel instead of the adoption of large engagement windows, the dog clutch may refuse to engage or could end up with damaged engagement means (teeth).

When the resilient means are adopted in a series configuration the applied total load is the same for each of the resilient elements. As it is well known every elastic element has an allowed deformation limit. If this limit is surpassed the element is plastically deformed and therefore ends up not being operational. Therefor the differences in the spring constants among the resilient means or springs in a series configuration cannot be great.

For example in my proposal when a torsional spring is used as a first (softer) spring, this spring element can be a preloaded spring so that:

Tₚᵣₑ≥J*ωₘₐₓ+T_{f}

Where Tₚᵣₑ is the preloaded torque of the spring, J is the moment of inertia of the inner part of the divided gear wheel, ωₘₐₓ is the maximum angular acceleration/deceleration that can be achieved by the inner part of the divided gear wheel and T_{f} is the torque created by friction forces between the inner part and the assigned shaft. The preloaded spring is adapted in order to have negligibly deformed first elastic element before the engagement, regardless if the components accelerate, decelerate or both rotate with a constant angular velocity. As a result when the divided gear wheel is not engaged with the engaging part, stays in a neutral position with the softer spring element being negligibly deformed, despite any occurring acceleration or deceleration of the inner/outer part, due to the existence of the preloaded softer spring. Alternatively as a person skilled in the art understands, the so called neutral position can occur without the softer spring being preloaded, but in that case a higher spring constant (k) in comparison to the spring constant of the preloaded spring has to be adopted.

In my proposal the parallel positioning and the difference in the length (since the first elastic element is partially arranged within the second elastic element and protrudes out of the second elastic element on a front face) of the elastic elements permit great differences in spring constants that allow the completion of the engagement of the inner part of the divided gear wheel without causing any damage to the engagement means (teeth). As a person skilled in the art understands depending on engines torque and shafts acceleration, the demanded ratio between first spring's element resistance force during engagement and the needed rotational force to handle the maximum load is about 1/1000 (the first elastic element is partially arranged within the second elastic element and protrudes out of the second elastic element on a front face), in order to have smooth engagement and to have the demanded rotational force in order to handle the load. Therefore as can be seen, the configuration does not include a divided gear wheel, having two elastic elements in a parallel positioning, with the set of two elastic elements being consisted by elastic elements having different spring constants and spring lengths in relation to each other.

In the patent document DE219963 two concentric wheels connected with elastic elements are claimed and not a divided gear wheel. In this patent the softer elastic element is used in order to handle the occurring load and the stiffer elastic element in order to handle any occurring torque peaks. It is a way to overcame torque shocks.

In my proposal there is a parallel positioning in the elastic elements and a difference in length (i.e. the first elastic element is partially arranged within the second elastic element and protrudes out of the second elastic element on a front face) between the elastic elements that have different spring constants. The elastic element with the smaller spring constant, that is longer in relation to the elastic element with the greater spring constant, after its initial deformation, does not bear any significant load. The handling of the load of the elastic element with the smaller spring constant (which handles about 0.1% of the maximum occurring load) is used in order to achieve a smooth engagement between the inner part of the divided gear wheel and the engagement component which is torque proof fixed with the assigned shaft. The elastic element that is shorter in relation to the initially deformed elastic element has a greater spring constant and it is assigned with the task of handling the main load.

In addition the inner part of the divided gear wheel is partially arranged within the outer part and therefore less space is demanded. The outer part comprises teeth adapted to engage with other gear wheels and the inner part comprises engagement means adapted to engage with the dog clutch or any other suitable engagement component. Therefore as can be seen, the proposed configuration of the patent document includes concentric wheels and does not include a divided gear wheel, having the two elastic elements positioned in a compartment formed by gear wheel parts.

Another positive aspect of my proposal is that even if the angle of the helical guiding means is equal to zero (straight guiding means), an effortless engagement can take place without damaging the engagement means. This is a result of the small inertia of the inner part of the divided gear wheel, which is the part that engages with the engagement component, and the existence of the first soft elastic element, which has a small resistance.

There are numerous other patent documents, but none of which incorporates a divided gear wheel adapted in a power transmission system, comprising two elastic elements wherein the two elastic elements are at least partially arranged in a compartment formed by gear wheel parts, wherein the set of two elastic elements comprises elastic elements with different spring constants and spring lengths in relation to each other.

Thus, it is the object of the present application to provide an automatic power transmission system, particularly for automotive vehicles, that at least partly overcomes the aforementioned drawbacks. In particular, the automatic power transmission system allows for continuously transferring power when shifting gear ratios and for reduced power losses due to friction.

### SUMMARY

The above objects are at least partly solved by a divided gear wheel according to claim 1, an automatic power transmission system according to claim 2, a method to operate an automatic power control transmission system according to claim 12 and an automotive vehicle according to claim 14.

In particular, the objects are at least partly achieved by a divided gear wheel for an automatic power transmission system, wherein the divided gear wheel comprises an inner part, being engageable with a shaft and an outer part, comprising teeth that are adapted for torque transmission to another gear wheel. The inner part and the outer part have a common rotational axis. Further, the inner part is at least partially arranged within the outer part and the inner part is coupled to the outer part by means of two elastic elements, so that the inner part is arranged angularly deflectable with respect to the outer part around the common rotational axis. The inner and the outer part are adapted to rotate with the same angular speed if the elastic elements are fully loaded. The inner part can transfer force and/or torque to the outer part via the elastic elements. If the inner part is angularly deflected with respect to the outer part the corresponding elastic elements are compressed or decompressed, depending on the direction of deflection and the arrangement of the elastic elements. Further, inner part can be coupled to the outer part by means of multiple elastic elements. These elastic elements can be arranged, that a first elastic element is compressed, and a second elastic element is decompressed accordingly, when the inner part is angularly deflected with respect to the outer part. Due to this compression/decompression of the elastic elements, forces and/or torque can be transferred from the inner part to the outer and vice versa.

The inner part is engageable with a shaft, such as an input shaft or an output shaft. The engagement can be permanently or temporally. A permanent engagement leads to a fixed gear and can be achieved e.g. by using a spline shaft, a shaft key or other known keyed joints. For providing a free gear, the engagement is established temporary and therefore, the inner part may comprise at least one engagement mean that is adapted to engage with an engaging part, wherein the engaging part temporarily fixes the inner part of the divided gear wheel so as to rotate with an assigned shaft. Accordingly, rotational forces can be transferred from the inner part to the shaft and vice versa.

The outer part forms the actual gear portion and comprises teeth. Accordingly, the outer part may comprise any type of gearing, such as a spur gear, a helical gear, a screw gear, a bevel gear, a spiral beveled gear, hypoid gear, a crown gear, a worm gear, or the like.

As the inner part is deflectable with respect to the outer part and is coupled to the outer part by means of two elastic elements, differences in angular velocity during a gear ratio changing action can be compensated and power losses can be reduced. This is, as during the gear ratio changing action the elastic elements are loaded, due to a difference in angular velocity between the inner part of the divided gear and an engaging part (in case the divided gear is a free gear) or due to a difference in angular velocity between the outer part and the inner part (in case the divided gear is a fixed gear). The loaded elastic elements thus can store power and return the stored power to the system that otherwise would lead to losses.

The elastic elements can be a spring elements, such a torque spring or a spiral spring, or any other elastic element, such as a rubber element. Further, different types of elastic elements can be combined in a divided gear wheel in order to achieve a desired spring characteristic.

The two elastic elements may be spring elements and may be received within a spring compartment, formed by the inner part and the outer part. Forming a spring compartment allows for protecting the elastic elements or spring elements from being distorted by environmental influences such as dust or dirt. In particular, the spring compartment can be a closed compartment. Alternatively, the spring compartment may be an open compartment that allows heat exchange and a facilitated maintenance of the springs.

By providing several elastic elements, the spring characteristics can be adjusted more easily. Further, it is possible to combine spring and damping elements. The maximum deflection angle of the inner part is inter alia dependent on the number of elastic elements used. If only two elastic elements are provided, the maximum deflection angle may be well above 180°, e.g. in a range of 200° to 340°. However, using two elastic elements allows to provide a relatively stiff system, with using small springs, as the overall spring rate is calculated of the sum of the spring rates of the single elastic elements.

Particularly, a first spring element may be partially arranged within a second spring element and may protrude out of the second spring element on a front face, wherein a spring rate of the first spring element may be lower than a spring rate of the second spring element. For example, a set of two spring elements can be incorporated in a divided gear wheel. The set of spring elements will comprise one spring element having a bigger diameter concentrically placed to a spring element having a smaller diameter. Further, if these spring elements have different spring rates, the “softer” spring element will begin to deform initially upon deflection of the inner part and subsequently the “stiffer” spring element will be deformed. Thus, a step-wise spring characteristic can be achieved, resulting in smooth gear ratio changing actions. Further, with providing a “softer” spring element, the engagement between the inner part and the respective shaft is facilitated. Particularly, the engagement between an engagement means of the inner part and a respective engaging part is facilitated, as the force that is required to move the engaging part axially into engagement (e.g. by a sequential shift actuator as will be described in greater detail below) can be reduced.

Further, the inner part may comprise engagement means that are adapted to engage with an engaging part of an automatic power transmission system, wherein upon engagement, the inner part is torque proof engaged with a shaft. This allows to provide a free gear for being used to define a gear ratio. The engagement means can be provided on an inner circumferential surface of the inner part, facing an assigned shaft. Further, engagement means can be provided on a front face of the inner part of the divided wheel. The engagement means can comprise grooves and/or recesses.

The objects are further at least partly achieved by an automatic power transmission system, e.g. for an automotive vehicle, that comprises an input shaft, supporting input gear wheels and an output shaft, supporting output gear wheels. Each of the input gear wheels engages with a corresponding output gear wheel, thereby defining a gear ratio. At least one of the input gear wheels and/or at least one of the output gear wheels of a gear ratio is a divided gear wheel as described above. The automatic power transmission system further comprises at least one engaging part that is assigned to the input shaft or the output shaft and to at least a divided gear wheel. The engaging part is arranged axially movable along the assigned shaft to change a gear ratio, wherein the engaging part is adapted to engage with the inner part of the divided gear wheel, thereby torque proof fixing the inner part with the shaft.

A gear ratio is formed by two gear wheels, wherein a first gear wheel is a fixed gear wheel, i.e. permanently engaged with a shaft, and a second gear wheel is a free gear wheel, i.e. adapted to be temporarily engaged with a shaft. Either of the first or second gear wheels can be an input gear wheel or an output gear wheel. Further, at least one of the first and second gear wheels is a divided gear wheel as described above. As the inner part of the divided gear wheel is deflectable with respect to the outer part of the divided gear wheel and as the inner part is coupled to the outer part by means of two elastic elements, differences in angular velocity during a gear ratio changing action can be compensated and power losses can be reduced.

The input shaft may be powered by an engine and the output shaft may be adapted to power the wheels of an automotive vehicle. By engaging the engaging part with an assigned divided gear wheel, the inner part of the divided gear wheel is torque proof fixed to the assigned shaft. By this engagement of the engaging part with the divided gear wheel power transfer can be achieved. Accordingly, by engaging different divided gear wheels different gear ratios can be chosen. The engaging part can be assigned to a single divided gear wheel or to multiple divided gear wheels.

In the first case, each divided gear wheel of the power transmission system that is also a free gear is assigned to a separate engaging part. In the second case, an engaging part can engage with different divided gear wheels. However, after having finished a gear ratio changing action, only a single engaging part is engaged with a divided gear wheel (first case) or the engaging part is assigned with a single divided gear wheel (second case). During the gear ratio changing action, the engaging part may be at least partially engaged with two adjacent divided gear wheels, as will be explained in greater detail with respect to FIGS. 5 and 6. The elastic elements of the divided gear wheels of a gear ratio may compensate differences in angular velocity during a gear ratio changing action and may reduce power losses.

The engaging part may be arranged concentrically to the assigned shaft and the axial movement of the engaging part along the assigned shaft may be guided by a helical means, so that the engaging part is rotated relative to the assigned shaft upon axial movement.

In an initial state, the automatic power transmission system may operate with a first gear ratio. Accordingly, power is transferred from the input shaft to the output shaft by means of a first pair of gear wheels that define the first gear ratio. A second gear ratio may be defined by a second pair of gear wheels. To change the gear ratio, from the first to the second gear ratio, the free, divided gear wheel of the first pair of gear wheels must be disengaged and the free, divided gear wheel of the second pair of gear wheels must be engaged with the respective shaft. The engagement is achieved by means of an engaging part that is assigned to the free, divided gear wheel of the second pair of gear wheels. In the initial state, the engaging part rotates with an angular velocity that is different from the angular velocity of the free, divided gear wheel of the second pair of gear wheels. By guiding the engaging part along the assigned shaft by helical means, so that the engaging part is rotated relative to the assigned shaft upon axial movement, the engaging part can be rotationally accelerated (or decelerated) in order to at least partially synchronize with the angular velocity of the free, divided gear wheel of the second pair of gear wheels. Thus, upon engagement, the engaging part rotates with an angular velocity similar to that of the free, divided gear wheel of the second pair of gear wheels. Remaining differences can be compensated by the elastic elements. Thus, power can be transferred permanently during the gear ratio changing action.

The helical means may be integrally formed with the assigned shaft. In particular, the helical means can comprise at least one helical groove or at least one helical protrusion that is adapted to guide the engaging part helically, i.e. in a combined axial and rotational movement. An integrally formed helical means allows for a facilitated assembly of the automatic power transmission system. Further, the helical means can be provided in form of a separate part that is torque proof engaged with the assigned shaft. Thus, the dimensions of the actual shaft can be reduced, and notch tension can be avoided.

The helical means may comprise a helix angle α, that follows the equation

$$Δ ω = \frac{{U}_{v}}{R} {{U}_{v} = tan ( α ) \cdot {U}_{a}}_{\to } Δ ω = \frac{tan ( α ) \cdot {U}_{a}}{R}$$

$$or$$

$${U}_{a} = \frac{R \cdot Δ ω}{tan ( α )}$$

wherein Δω defines a difference in angular velocity at the beginning of a gear ratio changing action between the assigned shaft and a gear wheel to be engaged, wherein Uₐ is a desired velocity of the axial movement, and wherein R is the effective radius of the helical means. Uᵥ is the vertical velocity of the engaging part. The given parameters are depicted in FIG. 1.

By choosing the helical angle α and the desired velocity of the axial movement Uₐ according to the above equation the absolute values of the angular velocities of the engaging part and the respective divided gear wheel that is going to be engaged, are substantially equal upon engagement and as a result smooth engagement can be achieved. In particular, a difference in angular velocity Δω between the engaging part and the respective divided gear wheel can be compensated. The smaller helix angle α is chosen, the greater would be the required velocity of the axial movement Uₐ and therefore the force, applied by an actuator to move the engaging part axially, increases.

For example, the engaging part is moved axially with an axial velocity Uₐ to engage with a divided gear wheel. In addition due to the helical guiding, the engaging part is rotationally accelerated so as to have a relative angular velocity Δω (in comparison to the rotating shaft) which equals to Uᵥ/R, where Uᵥ is the vertical velocity of the engaging part and R is the effective radius of the helical means (cf. FIG. 1, D is the respective diameter, so R=D/2). The relative angular velocity Δω should be equal to the difference of the angular velocities between the shaft at the beginning of the gear ratio changing action and the divided gear wheel that is to be engaged. As a result, the angular velocities of the engaging part and the respective divided gear wheel that is going to be engaged, are substantially equal upon engagement and as a result smooth engagement can be achieved.

The helical means may comprise at least one helical groove and the engaging part may comprise at least one helical arm, being guided in the helical groove. A corresponding engagement means may be arranged at the helical arm, preferably at a distal end thereof, and may be adapted to engage with an engagement means provided on an inner circumferential surface of the inner part of the divided gear wheel.

The helical groove(s) and helical arm(s) provide for the helical guiding. In particular, the helical groove(s) may be integrally formed within the assigned shaft. Further, the engaging part comprising helical arm(s) may be assigned to multiple divided gear wheels. This is, as the helical arm(s) and the corresponding engagement means can be pushed through a first divided gear wheel, which runs freely on the shaft and can engage a second consecutive divided gear wheel. The number of gear wheels the engaging part may be assigned to depends on the length of the helical arm(s) and the distance from center to center along the assigned shaft between the respective divided gear wheels. As the engaging part may be assigned to multiple divided gear wheels, gear ratio changing is facilitated, as only the single engaging part has to be axially moved.

The helical means may comprise at least one helical tooth on an outer circumferential surface and the engaging part may comprise a bushing portion having at least one corresponding helical tooth provided on an inner circumferential surface. A corresponding engagement means may be arranged at the bushing portion and may be adapted to engage with the engagement means of the inner part of the divided gear wheel, wherein the engagement means are preferably provided on an outer circumferential surface and/or a front face of the of the inner part of the divided gear wheel.

This design allows to assign separate engaging means to every free divided gear wheel. Thereby, the free divided gear wheels can be provided on both, the input and output, shafts. Thus, the automated power transmission system can be provided with reduced length dimensions. Further, the helical means can be provided as a separate part that is torque proof fixed to the shaft(s). Thus, the shaft design can be facilitated and notch tensions can be reduced.

At least one gear ratio of the automatic power transmission system may be defined by two divided gear wheels. One of these divided gear wheels is a free gear wheel, wherein the other one is a fixed gear wheel. Providing both gear wheels of a gear ratio as divided gear wheels, allows a prolonged time for engagement/disengagement. Particularly, the divided gear wheels can compensate a larger difference in angular velocity between the engaging part and the divided gear wheel to be engaged and therefore the engaging part can be less accelerated.

For example, if the difference in angular velocity between the engaging part and the divided gear wheel to be engaged would be 400 rpm, the time for one revolution would be 150 ms. If the inner part of the divided gear wheel would be deflectable by about 120° (spring deflection) and as the engaging part shall be engaged as long as the elastic element is not fully loaded, the time for engaging (engagement time) would be about 50 ms. Accordingly, if the difference in angular velocity would be just 200 rpm, the time for one revolution would be 300 ms. A 120° deflectable inner part of the divided gear wheel would thus provide a maximal engagement time of about too ms. If two divided gear wheels are present, the time for engaging is twice as long, provided that both divided gear wheels provide the same spring deflection.

The difference in angular velocity between the engaging part and the divided gear wheel to be engaged may be up to 1500 rpm, preferably up to 1000 rpm and even more preferably up to 700 rpm. A small difference in angular velocity between the engaging part and the divided gear wheel to be engaged allows for an increased engagement time, as shown by way of example, above. Thus, the actuator that moves the engaging part axially, such as a sequential shift actuator, can be driven with less power, if the difference in angular velocity is small.

Small differences in angular velocity can be achieved by providing multiple gear ratios. Assuming a desired revolution range of a vehicle, such as a truck or the like, in a range between 600 rpm and 2200 rpm and providing an automated power transmission system, having e.g. 20 (equally distributed) different gear ratios, would allow for a difference in angular velocity between the single gear ratios of about 80 rpm. If e.g. only 6 gear ratios would be provided, such as in common automotive vehicles, the difference in angular velocity would be about 266 rpm.

Generally, the automatic power transmission system may comprise an additional set of gear wheels provided upstream the first gear ratio, to reduce the engines revolutions. Further, the automatic power transmission system may comprise a further additional set of gear wheels provided downstream the last gear ratio of the automatic power transmission system, i.e. at the end of the output shaft for multiplying the output revolution. The gear ratio of these additional upstream and/or downstream set of gear wheels can be chosen according to the intended field of application. Accordingly, the gear ratio i may be greater, equal or smaller than 1.

The automatic power transmission system may comprise at least one additional gear wheel that is supported by the input shaft and/or the output shaft, wherein the additional gear wheel preferably engages with a gear wheel of a planetary gear. Particularly, the automatic power transmission can be combined with any known gear.

Further, the automatic power transmission system may comprise a sequential shift actuator, adapted to axially move the at least one engaging part to change a gear ratio. The sequential shift actuator may be designed so that only one free, divided gear wheel is in engagement with the assigned shaft (after a finished gear ratio changing action). Accordingly, the shift actuator may simultaneously axially move several engaging parts. Thus, a sequential gear ratio changing can be achieved.

The actuator may be a mechanical, a hydraulic, an electric or a pneumatic actuator, or the like. The actuator may be adapted to push (or pull) the engaging part with different axial velocities (depending on the needs/matching the needed Δω) resulting in smooth engagement between the concerning parts.

The automatic power transmission system may further comprise a control unit that is adapted to command a gear ratio changing action. The control unit may be fully automatic, so as to operate the engine at a desired operating point, and/or the control unit may forward user commands so as to allow the user to command a desired gear ratio.

The objects are further at least partly achieved by a method for operating an automatic power transmission system, the method comprising the following steps: Rotating the input shaft and transferring power to the output shaft by means of a first gear ratio. Commanding a gear ratio changing action from a first gear ratio to a second gear ratio. Axially moving at least one engaging part, and thereby disengaging the inner part of the divided gear wheel of the first gear ratio from the torque proof fixing with the shaft and engaging the inner part of the divided gear wheel of the second gear ratio, thereby torque proof fixing said inner part with the shaft, wherein the inner part of the divided gear wheel of the second gear ratio is angularly deflected with respect to the outer part and loads the elastic element. Rotating the input shaft and transferring power to the output shaft by means of the second gear ratio. Depending on the design of the engaging part(s) either one engaging part has to be moved, i.e. if the engaging part is assigned to multiple divided gear wheels, or at least two engaging parts have to be moved upon a gear ratio changing action, i.e. if the engaging parts are assigned to a respective single divided gear wheel. In this case a first engaging part engages the divided gear wheel to be engaged and a second engaging part disengages the actually engaged divided gear wheel. As a result, at the end of the gear ratio changing action only one divided (free) gear wheel is engaged.

Further, during axial moving the at least one engaging part, the engaging part may be guided by a helical means and rotated relative to the assigned shaft to compensate for a difference in angular velocity at the beginning of the commanded gear ratio changing action between the assigned shaft and the gear wheel to be engaged of the second gear ratio. Thus, a smooth gear ratio changing action can be achieved.

The objects are further at least partly achieved by an automotive vehicle comprising a divided gear wheel or an automatic power transmission system as described above.

### BRIEF DESCRIPTION OF THE FIGURES

In the following, preferred embodiments of the present invention are described with respect to the accompanying figures.

FIG. 1 is a schematic illustration of an output shaft, supporting two output gear wheels;

FIG. 2 is a schematic perspective view of an automatic power transmission system according to a first embodiment;

FIG. 3 is a schematic side view of an engaging part;

FIG. 4 is a schematic cut view of an input gear wheel and an output gear wheel, defining a gear ratio;

FIGS. 5A to C give a schematic illustration of a gear ratio changing action sequence;

FIG. 6A to C give a further schematic illustration of the gear ratio changing action sequence illustrated in FIG. 5;

FIG. 7 is a schematic cut view of an automatic power transmission system according to a second embodiment;

FIG. 8A is a schematic top view of an automatic power transmission system according to the second embodiment;

FIG. 8B is a schematic cut view of an input gear wheel and an output gear wheel, defining a gear ratio;

FIGS. 8C and 8D are schematic detailed views of an engaging part, being engaged/disengaged with an inner part of a divided gear wheel;

FIG. 9 is a schematic cut view of a further engaging part;

FIG. 10 is a schematic perspective view of an automatic power transmission system,

FIGS. 11A and 11B are a schematic illustrations of an automatic power transmission system;

FIGS. 12A to 12E give a schematic illustration of a gear ratio changing action sequence presenting a gradient torque transfer, and

FIG. 13 gives a schematic illustration of individual components of a divided gear wheel.

### DETAILED DESCRIPTION

As will become apparent from the following, the present application allows to provide a sequential automatic power transmission system that delivers power continuously without power losses from friction between clutch disks, due to the absence of clutch disengagement (or engagement) in every gear ratio changing action.

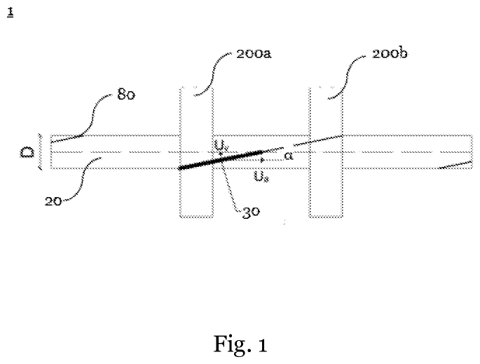

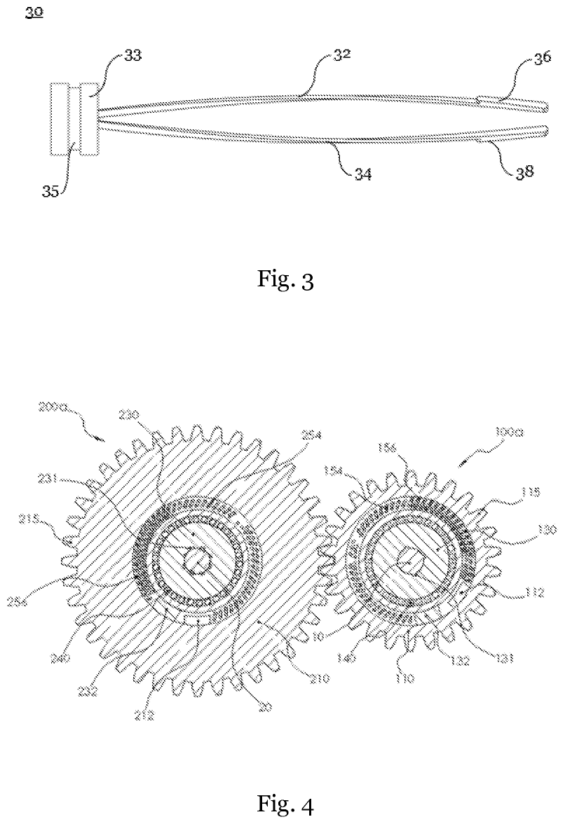

FIG. 1 is a schematic illustration of an output shaft 20, supporting two output gear wheels 200a, 200b. The output shaft 20 is provided with helical means 80 that are provided in form of a helical groove. The helical means serve to guide an engaging part 30. The engaging party 30 is depicted in greater detail in FIG. 3. The output gear wheels 200a, 200b may be divided gear wheels, as depicted in FIG. 4. The helical means 80 has a helix angle α that follows the equation

$$Δ ω = \frac{{U}_{v}}{R} {{U}_{v} = tan ( α ) \cdot {U}_{a}}_{\to } Δ ω = \frac{tan ( α ) \cdot {U}_{a}}{R}$$

wherein Δω defines a difference in angular velocity at the beginning of a gear ratio changing action between the assigned shaft and a divided gear wheel to be engaged, wherein Uₐ is a desired velocity of the axial movement, and wherein R is the effective radius of the helical means. Uᵥ is the vertical velocity of the engaging part. The given parameters are depicted in FIG. 1.

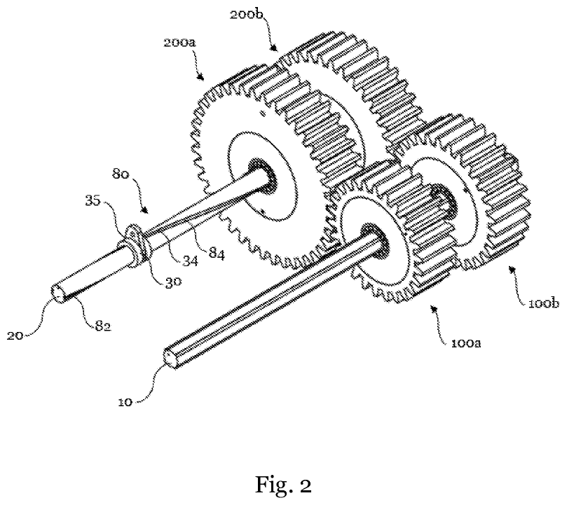

FIG. 2 is a perspective view of an automatic power transmission system according to the first embodiment. The automatic power transmission system 1 that is depicted in FIG. 2 comprises an input shaft 10 and an output shaft 20. The input shaft 10 supports the input gear wheels 100a, 100b. The output shaft 20 supports the output gear wheels 200a, 200b. It is apparent that the automatic power transmission system can comprise multiple input and output gear wheels and is not limited to the two pairs of input/output gear wheels, depicted in FIG. 2.

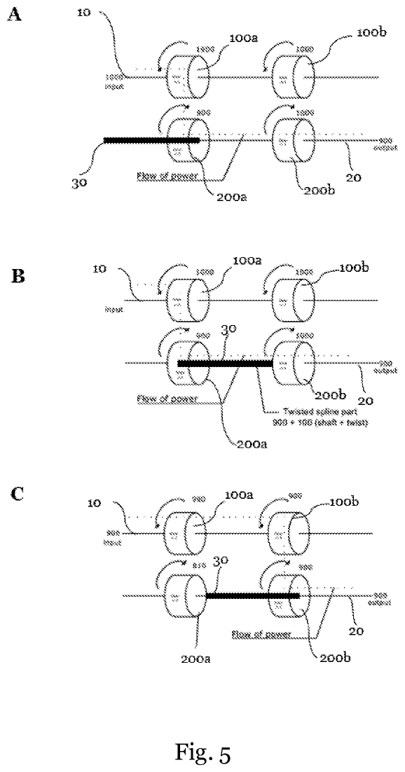

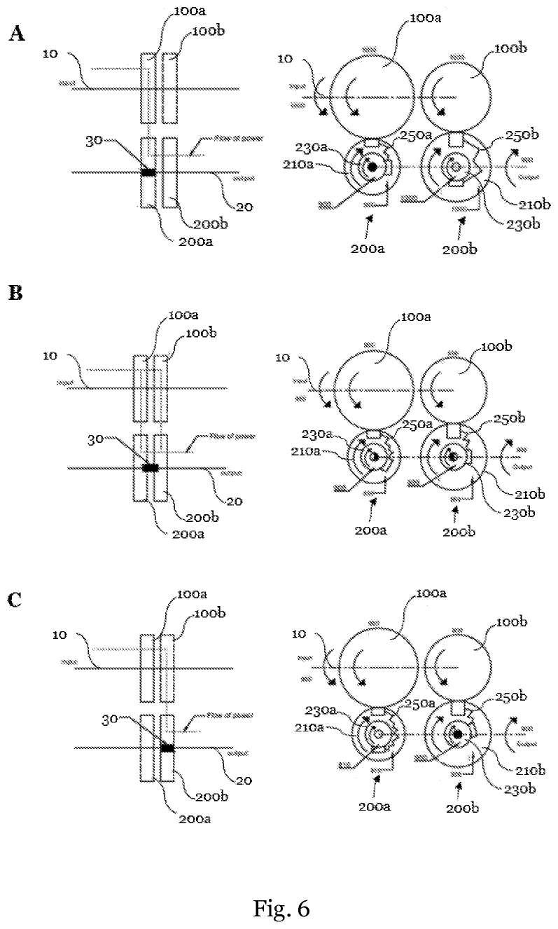

Input gear wheels 100a, 100b are fixed gear wheels, i.e. they rotate with the same speed as the input shaft to. Further, input gear wheels 100a, 100b can be divided gear wheels, wherein an inner part of the respective divided gear wheel is torque proof fixed to the input shaft 10 (see e.g. FIG. 4). Output gear wheels 200a, 200b are free gear wheels and are provided as divided gear wheels. Accordingly, if the engaging part 30 is not engaged with the respective output gear wheel 200a, 200b, the output gear wheel 200a, 200b can freely rotate on the output shaft 20. This means that the output shaft 20 and the respective output gear wheels 200a, 200b may have different angular velocities. The engaging part 30 is guided by the helical means 80, which defines two helical grooves 82, 84. The helical grooves 82, 84 receive respective helical arms 32, 34 of the engaging part 30. Further, the engaging part 30 comprises a bushing portion 33 having an actuator coupling in form of a groove or a notch, that is adapted to couple with an actuator that moves the engaging part 30 axially along the output shaft 20 as will be described in greater detail with respect to FIGS. 5A to 6C.

FIG. 3 is a detailed side view of an engaging part 30. The engaging part 30 comprises a bushing portion 33 that is guided on the output shaft 20. Helical arms 32, 34 extend from the bushing portion 33 and are provided at a distal end with corresponding engagement means 36, 38 that are adapted to engage with engagement means 231 of inner parts 230 of output gear wheels 200. The bushing portion 33 may further be provided with an actuator coupling 35 in form of a groove.

FIG. 4 is a schematic cut view of an input gear wheel 100a, that is in an engagement with an output gear wheel 200a, defining a first gear ratio. The input gear wheel 100a is provided as a fixed divided gear wheel, wherein the output gear wheel 200a is provided as a free, divided gear wheel. Accordingly, the inner part 130 of the first gear wheel 100a is permanently torque prove fixed to the input shaft 10. An outer part 110 is coupled to the inner part 130 by means of spring elements 154, 156. The spring elements are received in spring compartments, formed by the inner and outer part 110, 130. A bearing 140 allows the outer part 110 to be deflected angularly around the inner part 130. The spring elements 154, 156 are supported by elastic element supports 112 and 132, that are preferably integrally formed with the inner part 110 or the outer part 130, respectively.

The first spring element 154 may be arranged concentrically within a second spring element 156, wherein the first spring element 154 has a smaller spring rate than the second spring element 156. The outer part 110 is provided with a gearing comprising teeth 115, to transfer torque to the output gear wheel 200a. The output gear wheel 200a is also a divided gear wheel, comprising an inner part 230 and an outer part 210. The outer part 210 is provided with a gearing, comprising teeth 215. Further, the inner part 230 is coupled to the outer part 210 by means of spring elements, 254, 256. The spring elements are supported by respective elastic element supports 232, 212 which are preferably integrally formed with the inner part 230 or the outer part 210, respectively. Spring element 254 may be a first spring element that is concentrically arranged within a second spring element 256 and that has a smaller spring rate as the second spring element 256. Further, the outer part 210 is supported by a bearing 240 that allows for deflecting the inner part 230 relative to the outer part 210. The inner part 230 further comprises engagement means 231, in form of grooves provided on an inner circumferential surface of the inner part 230, facing the output shaft 20. The corresponding engagement means 36, 38 of the engagement means 30 can be inserted into said engagement means 231 and achieve a temporary torque proof connection between the output shaft 20 and the inner part 230 of the output gear wheel 200a. The permanent torque proof connection between the input shaft 10 and the inner part 130 of the input gear wheel 100a is achieved by corresponding engagement means 131, such as a spline shaft or the like.

A schematic sequence of a gear ratio changing action is illustrated in FIGS. 5 and 6. In particular, FIG. 5 illustrates how an engaging part, being assigned to multiple divided gear wheels, works. FIG. 6 illustrates the function of the divided gear wheels. FIGS. 5 and 6 show schematically a power transmission system, comprising an input shaft 10, an output shaft 20 and two input gear wheels 100a, 100b and two output gear wheels 200a, 200b. The power transmission system may comprise further gear wheels that are presently not depicted. The pair of gear wheels 100a, 200a defines a first gear ratio and the pair of gear wheels 100b, 200b defines a second gear ratio. Further, the power transmission system comprises an engaging part 30. As illustrated, input gear wheels 100a, 100b are fixed gear wheels that can be conventional gear wheels or divided gear wheels. The output gear wheels 200a, 200b are free gear wheels that are provided as divided gear wheels. Accordingly, the first output gear wheel 200a comprises an inner part 230a that is coupled to an outer part 21a by means of two elastic elements 250a. The second output gear wheel 200b comprises an inner part 230b that is coupled to an outer part 210b by means of two elastic elements 250b.

FIGS. 5A and 6A depict the power transmission system being operated at the first gear ratio, i.e. the first output gear wheel 200a is engaged with the output shaft 20 by means of the engaging part 30. The second output gear wheel 200b is disengaged and rotates freely. FIGS. 5B and 6B depict the power transmission system upon a gear ratio changing action from the first gear ratio to the second gear ratio and FIGS. 5C and 6C depict the power transmission system being operated at the second gear ratio, i.e. the second output gear wheel 200b is engaged with the output shaft 20 by means of the engaging part 30. The first output gear wheel 200a is disengaged and rotates freely.

To arrive at the state shown in FIGS. 5A and 6A, i.e. operating the power transmission system at the first gear ratio, the power transmission system may be transferred from neutral to the first gear ratio with help of a clutch (not shown). Accordingly, the first pair of gear wheels 100a, 200a starts moving and the engine's power is transferred from the input shaft 10 to the output shaft 20 via the first pair of gear wheels 100a, 200a, defining the first gear ratio.

The second pair of gear wheels, i.e. gear wheels 100b, 200b are also engaged with each other. However, as gear wheel 200b is a free gear wheel and is not engaged with the output shaft (cf. FIGS. 5A and 6A), gear wheel 200b can rotate freely with respect to the output shaft freely. Accordingly, the second pair of gear wheels 100b, 200b does not transfer torque to the output shaft 20 (or vice versa). The same applies to further pairs of gear wheels (not shown) that define additional gear ratios.

When engine reaches a desired speed level, e.g. as it tends to leave a desired operation point, or when the driver commands a gear ratio changing action (e.g. from the first gear ratio to the second gear ratio), a control unit may command the respective gear ratio changing action. Accordingly, an actuator (not shown) may push (or pull) the engaging part 30 linearly. Due to the axial movement of the engaging part 30, the engaging part 30 will engage the following divided gear wheel 200b. As the actuator moves the engaging part axially, the engaging part will be forced to accelerate in rotational and axial direction due to the helical guiding. Thus, the engaging part 30 will rotate with the output shaft 30 and in addition with an angular velocity Δω. The dimensions and in particular the helix angle α of the helical means and the desired velocity of the axial movement of the engaging part Uₐ may be chosen so that the angular velocity of the engaging part 30 matches the angular velocity of the following divided gear wheel 200b, upon engaging. Accordingly, when the engaging part 30 reaches the divided gear wheel 200b, they will have the same angular velocity and as a result a smooth engagement can be achieved.

As shown in FIGS. 5B and 6B, when the engaging part 30 begins entering/engaging the inner part 230b of divided gear wheel 200b the two elastic elements 250b, in its interior begins to be compressed due to the deflection of the inner part 230b. In this point of time, engaging part 30 is still partially engaged with the first output gear wheel 200a. This is, as the length of the corresponding engagement means 36, 38 that engage with the engagement means 231 of the inner parts 230a, 230b of the divided gear wheels 200a, 200b may be equal to the distance from center to center between two consecutive divided gear wheels 200a, 200b.

The two elastic elements 250b, may comprise a first spring element that is partially arranged within a second spring element and protrudes out of the second spring element on a front face. The spring rate of the first spring element may be smaller than the spring rate of the second spring element. Thus, initially, the first spring element is compressed. Subsequently, if the inner part 230b reaches the second, stiffer spring element the second spring element starts to be compressed. Accordingly, power can be transferred via the spring elements and the inner part 230b to the output shaft 20. The two elastic elements of the previous gear ratio, such as the two elastic elements 250a, of the first output gear wheel 200a, begin to decompress simultaneously up till the engaging part 30 fully engages the desired gear ratio.

As further shown in FIGS. 5B and 6B, when the engaging part 30 is engaged with both output gear wheels 200a, 200b of the first and second gear ratio, the flow of power is transferred from both gear ratios. Consequently, when the engaging part 30 is engaged only with one output gear wheel 200a, 200b of either the first or the second gear ratio, the flow of power is transferred exclusively by the pair of gear wheels, defining the respective gear ratio, as illustrated in FIGS. 5C and 6C. As the engagement progresses, a greater amount of power will be transferred by the second gear ratio with equivalent decrease of transferred power by the first gear ratio. The reverse action will take place when a smaller gear ratio is desired, e.g. if the gear ratio changing action is from the second to the first gear ratio.

In the following an example gear ratio changing action is describer, using random numbers of angular velocity of the respective gear wheels. The first input gear wheel 100a may rotate with an angular velocity of 1000 rpm and the first output gear wheel 200a with an angular velocity of 900 rpm (both inner and outer parts 210a, 230a). The second input gear wheel 100b may also rotate with an angular velocity of 1000 rpm, as first and second input gear wheels are fixed gear wheels, as shown in FIGS. 5A and 6A. The second output gear wheel may rotate freely with an angular velocity of 1000 rpm (both inner and outer parts 210b, 230b). Therefor the first gear ratio will be 0.9 and the second gear ratio will be 1.

The engaging part 30 rotates with the same angular velocity as the output shaft 20, i.e. with goo rpm. Thus, the difference in angular velocity between the engaging part 30 and the second output gear wheel 200b is about 100 rpm

When a command is given to change the gear ratio, the engaging part 30 begins to move axially with the help of an actuator and is at the same time rotationally accelerated (due to the helical guiding). As a result, when the engaging part 30 reaches the inner part 230b of the second output gear wheel 200b it has an angular velocity, equal to the sum of the rotational speed of the shaft (900 rpm) and the rotational speed due to the helical guiding (e.g. 100 rpm).

Upon engaging the engaging part 30 with the inner part 230b of the divided gear wheel 200b, the engaging part 30 begins to decelerate, continuing the engagement between the two parts up till it is fully engaged. The outer part 210b of the divided gear wheel 200b still rotates with 1000 rpm and the inner part 230b also decelerates due to the engagement, i.e. it rotates with about 900 rpm. Accordingly, the two elastic elements 250b and in particular, a first spring element is compressed as the engaging part 30 engages the inner part 230b of the divided gear wheel 200b. When the second spring element of the two elastic elements 250b begins to bare load, the two elastic elements 25a (such as the second spring element) of the previous gear ratio (i.e. the first gear ratio) begins to decompress. When the decompression of the previous two elastic elements 250a is completed and the compression of the following two elastic elements 250b is also completed the power is only transferred via the pair of gear wheels 100b, 200b, forming the second gear ratio, as shown in FIGS. 5C and 6C.

When the engagement of the engaging part 30 and the second output gear wheel 200b completed, the second output gear wheel 200b rotates with an angular velocity of 900 rpm, and so does the second input gear wheel 100b, resulting in an engine velocity of 900 rpm.

In particular, as the engaging part 30 starts to engage/disengage with any of gear wheels 200a, 200b, the two elastic elements 250a, 250b are compressed, or decompressed, respectively. As soon as the two elastic elements 250b begins to compress, the other two elastic elements 25a begins to decompress. The total needed torque is the sum of torques in the output gear wheels 200a, 200b, when the engaging part 30 is partially engaged in both (scenario of FIGS. 5B and 6B). As a consequence, as the two elastic elements 250b compress, managing greater torque, and the two elastic elements 25a decompress, managing lesser torque up till the torque is fully borne by the second output gear wheel 200b. As a result, when the engagement of the engaging part 30 with the second output gear wheel 200b is completed, the flow of power is as follows: input shaft 10—second input gear wheel 100b—second output gear wheel 200b—output shaft 20. As power can be transferred during the gear ratio changing action, a continuous power transfer is established.

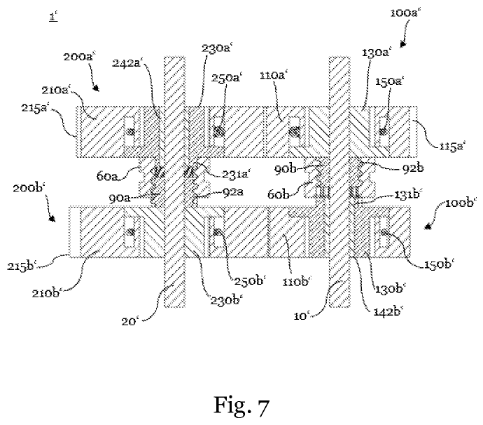

FIG. 7 is a cut view of an automatic power transmission system according to a second embodiment. The power transmission system 1′ shown in FIG. 7 comprises an input shaft 10′ and an output shaft 20′. The input shaft 10′ supports input gear wheels 100a‘ and 100b’ and the output shaft 20′ supports output gear wheels 200a′ and 200b′. As the skilled person will notice, the power transmission system 1′ can provide further input and/or output gear wheels that are supported on the input or output shaft, respectively. However, these gear wheels are not shown.

The input gear wheels 100a′, 100b′ and the output gear wheels 200a′, 200b′ are provided as divided gear wheels, each having an inner part 130a′, 130b′, 230a′, 230b′ and an outer part 110a′, 110b′, 210a′, 210b′. The pair of gear wheels 100a′, 200a′ defines a first gear ratio and the pair of gear wheels 100b′, 200b′ defines a second gear ratio.

The input gear wheel 100a′ is a fixed gear wheel, wherein the inner part 130a′ is permanently torque proof attached to the input shaft 10′. So is the output gear wheel 200b′. Accordingly, the inner part 230b′ is permanently torque proof attached to the output shaft 20′. As will become apparent from FIG. 7, each gear ratio is defined by a pair of gear wheels, wherein one of the pair of gear wheels is a fixed gear wheel and the respective other one is a free gear wheel. Accordingly, the output gear wheel 200a′ is a free gear wheel, comprising an inner part 230a′ that can freely rotate on the output shaft 20′, if it is not engaged with an engaging part 60a, as will be described later. Similarly, the input gear wheel 100b′ is a free gear wheel, comprising an inner part 130b′ that can freely rotate on the input shaft 10′, if not engaged with a respective engaging part 60b. To provide a freely rotating gear wheel, bearings 142b′ and 242a′ are provided between the input shaft 10′ and the inner part 130b′, respectively between the output shaft 20′ and the inner part 230a′.

The gear wheels 100a′, 100b′, 200a′, 200b′ are provided with respective gearings, comprising teeth 115a′, 215a′, 215b′. Further, the divided gear wheels 100a′, 100b′, 200a′, 200b′ each comprise respective inner parts 130a′, 130b′, 230a′, 230b′, that are coupled to respective outer parts 110a′, 110b′, 210a′, 210b′ by means of sets of two elastic elements 150a′, 150b′, 250a′, 250b′. This coupling allows for an angular deflection of the inner parts 130a′, 130b′, 230a′, 230b′ relative to the outer parts 110a′, 110b′, 210a′, 210b′. If the sets of two elastic elements 150′, 250′ are fully loaded, torque is transferred from the respective inner parts 130a′, 130b′, 230a′, 230b′ to the outer parts 110a′, 110b′, 210a′, 210b′ with a ratio of 1:1.

As shown, the automatic power transmission system 1′, as depicted in FIG. 7, differs from the automatic power transmission system 1, as e.g. depicted in FIG. 2, in particular in that the engaging part(s) is designed differently. This different engaging parts 60a, 60b allows to provide an automatic transmission system, having reduced length dimensions. This is, as each free divided gear wheel 100b′, 200a′ is assigned to a separate engaging part 60a, 60b. Accordingly, the free gears of adjacent gear ratios can be provided alternatingly on the input and output shaft 10′, 20′.

The engaging parts 60a, 60b are helically guided by respective helical means 90a, 90b that are provided as separate parts and that are attached torque proved to the respective input and output shafts 10′, 20′. The helical means 90a, 90b are provided with helical teeth 92a, 92b. This helical teeth guide the engaging part 60a, 60b helically, i.e. in an axial and rotational direction as described above.

Further, each free divided gear wheel comprises at its inner part 230a′, 130b′ engagement means 231a′, 131b′ that are adapted to engage with engagement means 66 of the engaging part 60a, 60b.

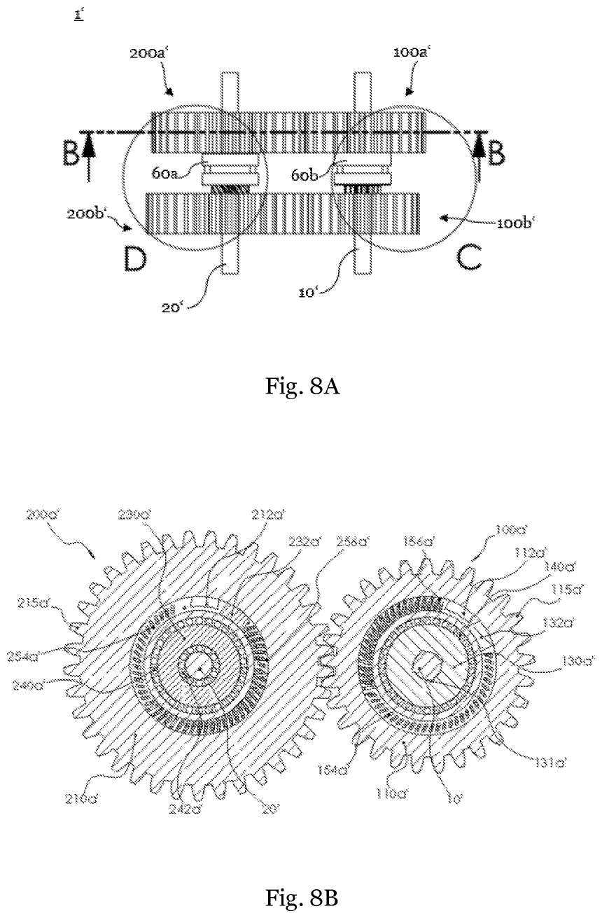

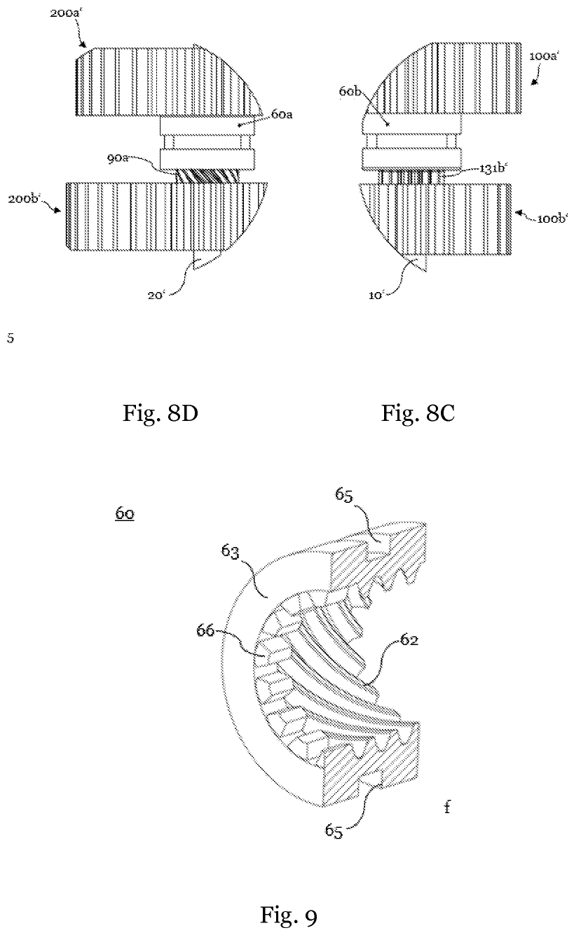

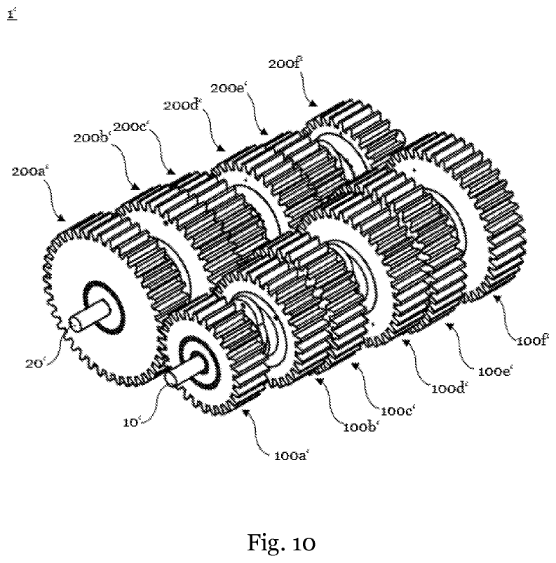

FIG. 8A shows a schematic top view of the automatic power transmission system 1′ of FIG. 7. The automatic power transmission system comprises an input shaft 10′ and an output shaft 20′ as well as input gear wheels 100a′, 100b′ and output gear wheels 200a′, 200b′. The free gear wheels 100b′, 200a′ can be temporarily torque proof attached to the respective input shaft 10′ or output shaft 20′ by means of engaging parts 60a, 60b. In the configuration shown in FIG. 8A, the output gear wheel 200a′ is engaged with the engaging part 6a thereby being able to transfer torque to the output shaft 20′. The engaging part 60b is disengaged and thus, the input gear wheel 100b′ cannot transfer torque to the input shaft 10′.

FIG. 8B is a schematic cut view of the first input gear wheel 100a′ and the first output gear wheel 200a′, that are in engagement with each other. The design of the input and output gear wheels 100a′ and 200a′ corresponds to the design of the gear wheels, discussed with respect to FIG. 4. In particular, the input gear wheel 100a′ corresponds to the input gear wheel 100a. The output gear wheel 200a′ differs from the output gear wheel 200a depicted in FIG. 4 in respect to the inner part 230a/230a′. In particular, the inner part 230a′ is supported by a bearing 242a′ on the output shaft 20′. No engagement means are provided on the inner circumferential surface of the inner part 230a′.

Those engagement means 231a′ are provided on a front face of the inner part 230a′ as shown in FIG. 7.

FIGS. 8C and 8D show detailed views of the engagement parts 60a, 60b. As shown in FIG. 8C, the engaging part 60b is disengaged and the engagement means 131b′ of input gear wheel 100b′ are not engaged with the engaging part 60b. FIG. 8D shows an engaged engaging part 60a. Accordingly, the engagement means of output gear wheel 200a′ are covered by the engaging part 6a and the helical means 9a can be seen in the top view of FIG. 8D.

FIG. 9 shows a cut view of an engaging part 60. The engaging part 60 comprises a bushing portion 63 that has on its inner circumferential surface corresponding helical teeth 62 that are in engagement with the helical teeth 92 of helical means 90, as shown e.g. in the previous figures. Thus, helical guiding of the engaging part 60 can be achieved. Further, corresponding engagement means 66 are provided, which are adapted to engage with engagement means of respective inner parts of the divided gear wheels 100′, 200′. On an outer circumferential surface of the bushing portion 63, an actuator coupling 65 is provided in form of a groove that allows an actuator to move the engaging part axially.

Figure to shows an example of an automatic power transmission system, comprising six gear ratios, defined by respective pairs of input gear wheels 100a′, 100b′, 100c′, 100d′, 100e′, 100f′ and output gear wheels 200a′, 200b′, 200c′, 200d′, 200e′, 200f. The input gear wheels are supported by the input shaft 10′ and the output gear wheels are supported by the output shaft 20′.

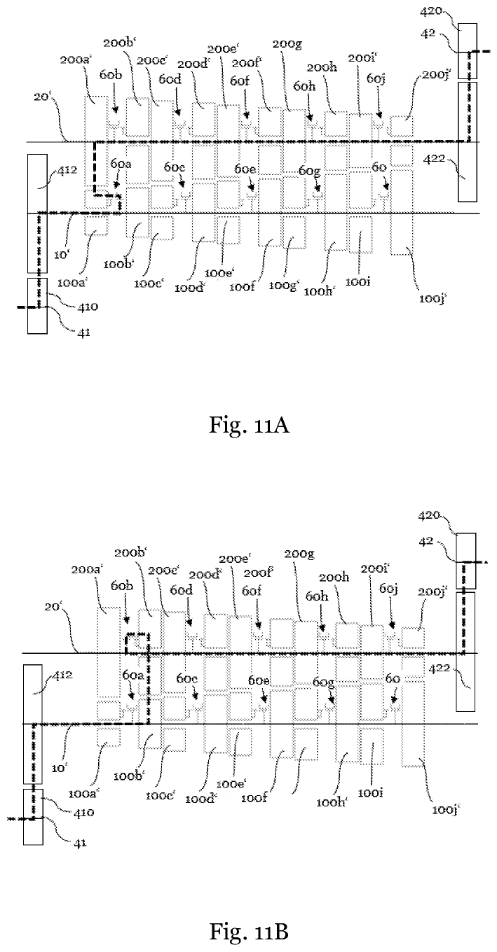

FIGS. 11A and 11B show schematic illustrations of an automatic power transmission system wherein according to FIG. 11A a first gear ratio is operated and according to FIG. 11B, a second gear ratio is operated. The first gear ratio is defined by the pair of gear wheels 100a′, 200a′ and the second gear ratio is defined by the pair of gear wheels 100b′, 200b′.

The flow of power is illustrated as bold dashed line. According to FIG. 11A, the power is transferred via the input shaft 10′ and the engaging part 6a to the input gear wheel 100a′ and then via the output gear wheel 200a′ to the output shaft 20′. According to FIG. 11B, the power is transferred via the input shaft 10′ and the input gear wheel 100b′ to the output gear wheel 200b′. Then, the power is transferred via the engaging part 60b to the output shaft 20′.

Further, the automatic power transmission system 1′ may comprise an additional set of gear wheels provided upstream the first gear ratio, to reduce the engines revolutions.

This set of gear wheels may comprise a primary input gear wheel 410, provided on a primary input shaft 41. The primary input gear wheel 410 may be coupled to a primary complementary input gear wheel 412, which is provided on the input shaft 10′. The flow of power may then be transferred from the primary input shaft 41 via the set of gear wheels 410, 412 to the input shaft 10′.

Additionally, or alternatively, the automatic power transmission system 1′ may comprise a set of gear wheels provided downstream the last gear ratio of the automatic power transmission system, i.e. at the end of the output shaft 20′. This set of gear wheels may comprise a subsequent output gear wheel 422, provided on the output shaft 20′. The subsequent output gear wheel 422 may be coupled to a subsequent complementary output gear wheel 420, which is provided on a subsequent output shaft 42. The flow of power may then be transferred from the output shaft 20′ via the set of gear wheels 422, 420 to the subsequent output shaft 42. As shown, the divided gear wheels that are free gear wheels are provided alternately on the input shaft 10′ and the output shaft 20′. Each free gear wheel is assigned with a respective engaging part 60a to 60j. To operate the depicted automatic power transmission system, only one engaging part of the set of engaging parts 60a to 60j is engaged with the respective divided gear wheel, at a time where no power ratio changing action is performed, i.e. when a gear ratio is operated. During power transfer changing actions, two engaging parts may at least partly be engaged with the respective gear wheels, as described above with respect to FIGS. 5A to 6C. To change the gear ratio, the power transmission system requires to change gear ratios sequentially. That means that to change a gear ratio from the first to e.g. the fifth gear ratio, all gear ratios that are sandwiched between the first and fifth gear ratio must be operated for a short period of time. Thus, no direct gear ratio change from the first to the fifth gear ratio is possible.

The above described automatic power transmission system, comprising divided gear wheels allows for a continuous power transfer during gear ratio changing actions and for reduced power losses.

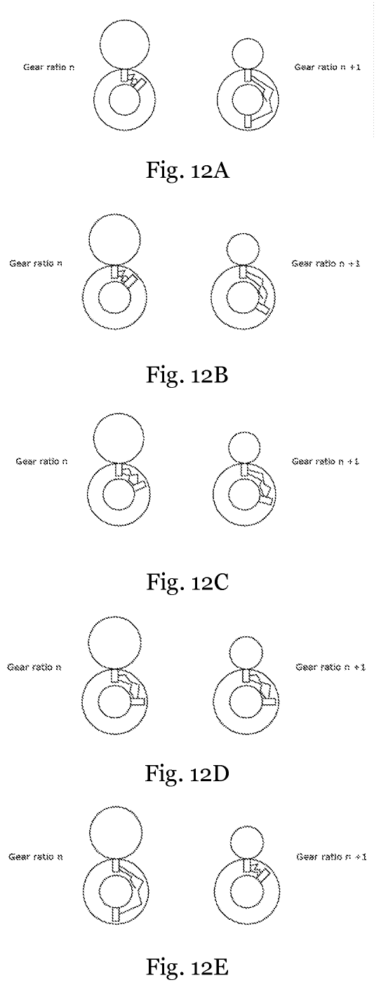

FIGS. 12A to 12E show schematic illustrations of the gradient torque transfer between gear ratio n to gear ratio n+1. In the demonstration the engaging part is guided by straight guiding means instead of helical (helix angle equal to zero). Therefore upon axial movement the engaging part rotates with the same angular velocity as the assigned shaft. This set of figures depicts two divided gear wheels of two consecutive gear ratios n, n+1 with both the divided gear wheels being engageable by an engaging part, and the depiction is a schematic equivalent to the previously explained configuration presented in FIG. 6A to 6C. Each engageable divided gear wheel meshes with a corresponding fixed (to the assigned shaft) gear wheel (presented as a tangent circle on top of the divided gear wheels) forming a gear ratio. The fixed gear wheels can either be divided gear wheels or gear wheels as previously mentioned.

As can be seen in FIG. 12A, the two elastic elements of gear ratio n are fully compressed and the two elastic elements of gear ratio n+1 are fully decompressed. Therefore gear ratio n is selected and the corresponding free divided gear wheel is engaged. The divided gear wheel of gear ratio n+1 is not engaged and therefore free to rotate and as a consequence 100% of the torque is transferred to output shaft by gear ratio n. The term “selected” is used when the “stiffer” elastic elements of a gear ratio, are compressed and the term “engaged” is used when the engaging part interacts with the inner part of the divided gear wheels. As a consequence a divided gear wheel can be “engaged” but the gear ratio not “selected” (i.e. the “stiffer” elastic elements are not compressed, but the “softer” elastic elements are). In contrast a gear ratio cannot be “selected” without the divided gear wheel of that gear ratio not being “engaged”.

In FIG. 12B a gear changing action is commanded by the CPU and corresponding engaging parts or part are moved.

As a result gear ratio n continues to be selected and engaged and gear ratio n+1 is engaged but not selected since only the “softer” elastic element of the two elastic elements starts to compress and provides the time for a complete engagement of the inner part of the divided gear wheel of gear ratio n+1.

When the engagement is completed only about 0.1% of the torque is transferred to output shaft by gear ratio n+1 (since the “stiffer” elastic element is not compressed at all) with an equal decrease in the transferred torque by gear ratio n. As can be seen the set of elastic elements of gear ratio n+1 is visually compressed due to the compression of the “softer” elastic element.

In FIG. 12C both gear ratios n and n+1 are selected and engaged.

As a consequence, the “stiffer” elastic elements of both gear ratios are compressed with the “stiffer” elastic element of gear ratio n+1 beginning to transfer torque to output shaft, with a corresponding decrease in the transferred torque (to the output shaft) by gear ratio n. For example 80% of the occurring torque is being transferred by gear ratio n and 20% by gear ratio n+1.

As can be seen in FIG. 12D, as time passes more torque is being transferred by gear ratio n+1 and less torque is being transferred by gear ratio n. As a result the two elastic elements of gear ratio n+1 are more compressed and the two elastic elements of gear ratio n are less compressed. At the presented stage equal amounts of torque are being transferred by each gear ratio.

Finally in FIG. 12E, gear ratio n+1 transfers 100% of the torque and gear ratio n is not selected nor engaged with its divided gear wheel rotating freely. The two elastic elements of gear ratio n are decompressed and the two elastic elements of gear ratio n+1 are compressed. At this stage the gear changing action is completed and gear ratio n+1 is selected. Since gear ratio n+1 transfers the 99.9% of the torque, the CPU can command the disengagement of gear ratio n.

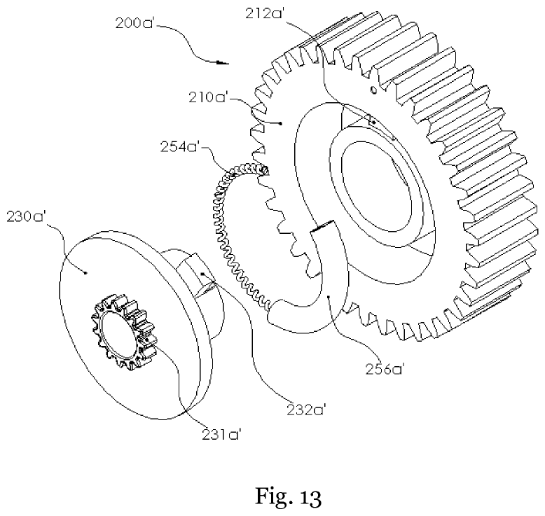

In FIG. 13 an alternative configuration of the two elastic elements inside a divided gear wheel is presented, with an exploded view of a divided gear wheel.

In this alternative the divided gear wheel 200a′ presented in FIGS. 7 to 8D comprises one spring element as a first elastic element and one rubber element as a second elastic element. More particularly the first softer elastic element 254a′ comprises a spring element and the second stiffer elastic element 256a′ comprises a rubber element.

The arrangement of the two elastic elements is the same as before with the first elastic element being partially arranged within the second elastic element and protruding out of the second elastic element on a front face. As it is obvious the rubber element comprises a corresponding cavity on its core in order to house the spring element. In addition the previously presented bearings have been omitted.

### LIST OF REFERENCE SIGNS

1 automatic power transmission system
10 input shaft
20 output shaft
30 engaging part
33 bushing portion
32 helical arm
34 helical arm
35 actuator coupling
36 corresponding engagement means
38 corresponding engagement means
41 primary input shaft
42 subsequent output shaft
60 engaging part
62 corresponding helical teeth
63 bushing portion
65 actuator coupling
66 corresponding engagement means
80 helical means
82 helical groove
84 helical groove
90 helical means
92 helical teeth
100 input gear wheel
110 outer part
112 elastic element support
115 teeth
130 inner part
131 engagement means
132 elastic element support
140 bearing
142 bearing
150 elastic element
154 elastic element (spring element)
156 elastic element (spring element)
200 output gear wheel
210 outer part
212 elastic element support
215 teeth
230 inner part
231 engagement means
232 elastic element support
240 bearing
242 bearing
250 elastic element
254 elastic element (spring element)
256 elastic element (spring element)
410 primary input gear wheel
412 primary complementary input gear wheel
420 subsequent complementary output gear wheel
422 subsequent output gear wheel

1. A divided gear wheel (100, 200), for an automatic power transmission system (1), wherein the divided gear wheel (100, 200) comprises
an inner part (130, 230), being engageable with a shaft (10, 20) and
an outer part (110, 210), comprising teeth (115, 215), adapted for torque transmission to another gear wheel, wherein
the inner part (130, 230) and the outer part (110, 210) have a common rotational axis, and wherein the inner part (130, 230) is at least partially arranged within the outer part (110, 210),
the inner part (130, 230) being coupled to the outer part (110, 210) by means of two elastic elements (154, 156, 254, 256), so that the inner part (130, 230) is arranged angularly deflectable with respect to the outer part (130, 230) around the common rotational axis, wherein
the inner part (130, 230) and the outer part (110, 210) are adapted to rotate with the same angular speed if the elastic elements (154, 156, 254, 256) are fully loaded, wherein
the first elastic element (154, 254) is partially arranged within the second elastic element (156, 256) and protrudes out of the second elastic element (156, 256) on a front face, wherein
a spring rate of the first elastic element (154, 254) is lower than a spring rate of the second elastic element (156, 256) and wherein
the inner part (130, 230) comprises engagement means (131, 231) that are adapted to engage with an engaging part (30, 60) of an automatic power transmission system (1), wherein upon engagement, the inner part (130, 230) is torque proof engaged with a shaft.

2. An automatic power transmission system (1), in particular for an automotive vehicle, comprising:
an input shaft (10), supporting input gear wheels (100);
an output shaft (20), supporting output gear wheels (200), wherein each of the input gear wheels (100) engages with a corresponding output gear wheel (200), thereby defining a gear ratio, wherein at least one of the input gear wheels (100) and/or at least one of the output gear wheels (200), of a gear ratio, is a divided gear wheel according to claim 1; and
at least one engaging part (300, 60), that is assigned to the input shaft (10) or the output shaft (20) and to at least a divided gear wheel, wherein the engaging part (30, 600) is arranged axially movable along the assigned shaft (10, 20) to change a gear ratio, wherein the engaging part (30, 600) is adapted to engage with the inner part (130, 230) of the divided gear wheel, thereby torque proof fixing the inner part (130, 230) with the shaft.

3. The automatic power transmission system (1) according to claim 2, wherein
the engaging part (30, 60) is arranged concentrically to the assigned shaft (10, 20), and wherein
the axial movement of the engaging part (30, 60) along the assigned shaft (10, 20) is guided by a helical means (80, 90), so that the engaging part is rotated relative to the assigned shaft upon axial movement.

4. The automatic power transmission system (1) according to any of claims 2 to 3, wherein the helical means (80, 90) is integrally formed with the assigned shaft (10, 20).

5. The automatic power transmission system (1) according to any of claims 2 to 4, wherein the helical means (80, 90) comprises a helix angle α, that follows the equation
$$Δ ω = \frac{tan ( α ) \cdot {U}_{a}}{R} ,$$
wherein
Δω defines a difference in angular velocity at the beginning of a gear ratio changing action between the assigned shaft and a gear wheel to be engaged, wherein
Uₐ is a desired velocity of the axial movement, and wherein
R is the effective radius of the helical means.

6. The automatic power transmission system (1) according to any of claims 2 to 5, wherein the helical means (80) comprises at least one helical groove (82, 84) and wherein the engaging part (30) comprises
at least one helical arm (32, 34), being guided in the helical groove (82, 84), and
a corresponding engagement means (36, 38) arranged at the helical arm (32, 34) and being adapted to engage with an engagement means (231) provided on an inner circumferential surface of the inner part (230) of the divided gear wheel (200).

7. The automatic power transmission system (1) according to any of claims 2 to 6, wherein the helical means (80, 90) comprises at least one helical tooth (92) on an outer circumferential surface and wherein the engaging part (60) comprises
a bushing portion (61) having at least one corresponding helical tooth (62) provided on an inner circumferential surface, and
a corresponding engagement means (66) arranged at the bushing portion and being adapted to engage with the engagement means (131, 231) of the inner part (130, 230) of the divided gear wheel (100, 200), wherein the engagement means (131, 231) are preferably provided on an outer circumferential surface and/or a front face of the of the inner part (130, 230) of the divided gear wheel (100, 200).

8. The automatic power transmission system (1) according to any of claims 2 to 7, wherein at least one gear ratio of the automatic power transmission system (1) is defined by two divided gear wheels (100, 200), according to claim 1.

9. The automatic power transmission system (1) according to any of claims 2 to 8, wherein at least one additional gear wheel is supported by the input shaft (10) and/or the output shaft (20), and wherein the additional gear wheel preferably engages with a gear wheel of a planetary gear.

10. The automatic power transmission system (1) according to any of claims 2 to 9, further comprising a sequential shift actuator, adapted to axially move the at least one engaging part (300, 60), to change a gear ratio.

11. The automatic power transmission system (1) according to any of claims 2 to 10, further comprising a control unit that is adapted to command a gear ratio changing action.

12. A method for operating an automatic power transmission system (1) according to any of claims 2 to 11, the method comprising the following steps:
rotating the input shaft and transferring power to the output shaft by means of a first gear ratio;
commanding a gear ratio changing action from a first gear ratio to a second gear ratio;
axially moving at least one engaging part (30, 600) and thereby disengaging the inner part (130, 230) of the divided gear wheel (100, 200) of the first gear ratio from the torque proof fixing with the shaft and engaging the inner part (130, 230) of the divided gear wheel (100, 200) of the second gear ratio, thereby torque proof fixing said inner part (130, 230) with the shaft, wherein the inner part (130, 230) of the divided gear wheel (100, 200) of the second gear ratio is angularly deflected with respect to the outer part (130, 230) and loads the elastic element (154, 156, 254, 256);
rotating the input shaft and transferring power to the output shaft by means of the second gear ratio.

13. The method according to claim 12, wherein during axial moving the at least one engaging part (30, 60) the engaging part (30, 600) is guided by a helical means and rotated relative to the assigned shaft to compensate for a difference in angular velocity at the beginning of the commanded gear ratio changing action between the assigned shaft and the gear wheel to be engaged of the second gear ratio.

14. An automotive vehicle comprising a divided gear wheel (100, 200) according to claim 1 or an automatic power transmission system (1) according to any one of claims 2 to 11.
